(19) United States
(12) Patent Application Publication
(10) Pub. No.: US 2015/0231491 A1
(43) Pub. Date: Aug. 20, 2015

(54) Advanced Game Mechanics On Hover-Sensitive Devices

(71) Applicant: Microsoft Corporation, Redmond, WA (US)

(72) Inventors: Dan Hwang, Renton, WA (US); Lynn Dai, Samamish, WA (US)

(73) Assignee: Microsoft Corporation, Redmond, WA (US)

(21) Appl. No.: 14/184,457

(22) Filed: Feb. 19, 2014

(51) Int. Cl. A63F 13/2145; G06F 3/041; A63F 13/42; G06F 3/0338

(52) U.S. Cl. CPC A63F 13/2145; G06F 3/0338; G06F 3/041; A63F 13/42

(57) ABSTRACT

Example apparatus and methods provide a virtual control for a video game played on a hover-sensitive device. A method may establish a hover point for an object located in a hover space produced by the device. The hover point may be associated with a three dimensional virtual joystick that may or may not be displayed. The virtual joystick processes inputs from the three dimensional hover space. The inputs have a z component. The z component may characterize, for example, a distance between the object and the device, or a rate at which the object is approaching or moving away from the device. The video game may be controlled in a third dimension based on the z component. For example, a character may crouch down or stand up based on the z component, or the area of a spell may be expanded or contracted based on the z component.

### BACKGROUND

Conventional game controllers typically have fixed joysticks and buttons. For example, a game controller may have joysticks anchored at the bottom left and right corners of the controller. Even when a device like a tablet or smart phone is being used as a game controller, the device still typically anchors user interface elements representing two dimensional joysticks in the bottom left and right corners of the device. This anchoring produces usability and functional issues including finger and hand occlusion where the fingers or thumbs get in the way of the screen real estate and thus get in the way of game play. The fingers or thumbs get in the way because the fingers or thumbs have to touch the fixed controls. The anchoring also produces functional issues where a user's fingers or thumbs may slip off a physical joystick or inadvertently exit the touch space where a two dimensional virtual joystick is anchored. The thumbs may move away from the virtual joystick during the excitement of rigorous game play. The functional issues may be exacerbated when the size, separation, or location of the joysticks are inconvenient for some users. For example, gamers with large or small hands or with long or short fingers may find the conventional joysticks difficult to use.

Gamers are familiar with using two joysticks and a number of buttons to control a first person game (e.g., driving game, boxing game) or a third person game (e.g., strategy game, squad based game). A first conventional joystick may typically control lateral movement (e.g., left/right) while a second conventional joystick may typically control front/back movement or may control the direction for weaponry In a first person combat game, different buttons may need to be pressed to cause an avatar to jump or crouch. In a first person driving game, different buttons may need to be pressed to control the gas pedal and the brake pedal. In a third person spell-casting game, different buttons may need to be pressed to control the area over which a spell may be cast and the intensity of the spell.

Conventional devices may have employed touch technology for game interactions with a user. Smartphones typically rely on touch interactions where gamers use their fingers to touch and manipulate objects on a touch display. For example, a conventional first person boxing game may present two virtual boxing gloves, one for the right hand and one for the left hand. When a user touches the left side of the screen their left glove punches and when a user touches the right side of the screen their right glove punches. While this may produce a fun and interesting game, it is limited with respect to the reality of first person combat (e.g., boxing, mixed martial arts (MMA)) games.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example methods and apparatus are directed toward providing a virtual interface element that supports controlling a video game in three dimensions. Example methods and apparatus may establish, in an apparatus that is displaying an output of a video game, a hover point for an object located in a hover space produced by the apparatus. The hover point may be related to a virtual interface element like a joystick or collective. Hover actions performed in the hover space above the virtual interface element may include information about their three dimensional location and movement. The hover actions may be translated or otherwise converted to inputs associated with the virtual interface element and then the inputs may be used to control the video game.

Some embodiments may include a capacitive input/output (i/o) interface that is sensitive to hover actions. The capacitive i/o interface may detect objects (e.g., finger, thumb, stylus) that are not touching the screen but that are located in a three dimensional volume (e.g., hover space) associated with the screen. The capacitive i/o interface may be able to detect multiple simultaneous hover actions. An apparatus may include logics that provide a virtual hover control for display on the input/output interface. The virtual hover control is responsive to an object in the hover space. The logics may process a hover event generated by the object to provide a first input to the virtual hover control. The first input will have a z dimension element. The logics may also produce a video game control event based on the first input. The video game control event controls an element of the video game in the z dimension. The object in the hover space may be bound to the virtual hover control so that the virtual hover control may travel with the object as it moves in the hover space.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example hover-sensitive device.

FIG. 2 illustrates a hover-sensitive device with a moving virtual joystick.

FIG. 3 illustrates a hover-sensitive device with a disappearing virtual joystick.

FIG. 4 illustrates hover actions associated with a punch, a fake, and a block.

FIG. 5 illustrates an example method associated with advanced game mechanics on hover-sensitive devices.

FIG. 6 illustrates an example method associated with advanced game mechanics on hover-sensitive devices.

FIG. 7 illustrates an example cloud operating environment in which a hover-sensitive device may provide advanced game mechanics for a hover-sensitive device.

FIG. 8 is a system diagram depicting an exemplary mobile communication device having a hover-sensitive interface that provides advanced game mechanics.

FIG. 9 illustrates an example apparatus that provides advanced game mechanics.

FIG. 10 illustrates a hover-sensitive i/o interface 1000.

FIG. 11 illustrates an example apparatus having an input/output interface, edge spaces, and a back space.

FIG. 12 illustrates an example apparatus providing a grip space.

FIG. 13 illustrates an apparatus where sensors on an input/output interface co-operate with sensors on edge interfaces to provide a grip space.

### DETAILED DESCRIPTION

Example apparatus and methods use hover technology to provide improved game mechanics. The advanced game mechanics may include providing a virtual input element that supports controlling a video game in three dimensions. The advanced game mechanics may establish a hover point in an apparatus that is displaying an output of a video game. The hover point may be associated with an object (e.g., gamer's thumb) located in a hover space produced by the apparatus. The hover point may be bound to or otherwise related to a virtual user interface element like a joystick or collective. Hover actions performed in the hover space above the virtual user interface element may include information about their three dimensional location and movement. The three dimensional information may be provided using, for example Cartesian (e.g., x/y/z) data, or other data (e.g., polar co-ordinates, range plus azimuth). The hover actions may be translated or otherwise converted to inputs associated with the virtual user interface element and then the inputs may be used to control the video game. Unlike conventional systems, the video game may be controlled in three dimensions using a single control.

Some embodiments may include a capacitive input/output (i/o) interface that is sensitive to hover actions. The capacitive i/o interface may detect multiple simultaneous hover actions. An example apparatus may provide a virtual hover control for display on the input/output interface. The virtual hover control is responsive to the object in the hover space. The apparatus may process a hover event generated by the object to provide inputs having a z dimension element to the virtual hover control. The apparatus may produce a video game control event based on the input. The video game control event may control an element of the video game (e.g., player position, player hand position, game effect) in the z dimension. The object in the hover space may be related to the virtual hover control in a way that facilitates having the virtual hover control travel with the object as it moves in the hover space.

Hover technology is used to detect an object in a hover space. “Hover technology” and “hover-sensitive” refer to sensing an object spaced away from (e.g., not touching) yet in close proximity to a display in an electronic device. “Close proximity” may mean, for example, beyond 1 mm but within 1 cm, beyond 1 mm but within 10 cm, or other combinations of ranges. Being in close proximity includes being within a range where a proximity detector (e.g., capacitive sensor) can detect and characterize an object in the hover space. The device may be, for example, a phone, a tablet computer, a computer, or other device/accessory. Hover technology may depend on a proximity detector(s) associated with the device that is hover-sensitive. Example apparatus may include the proximity detector(s).

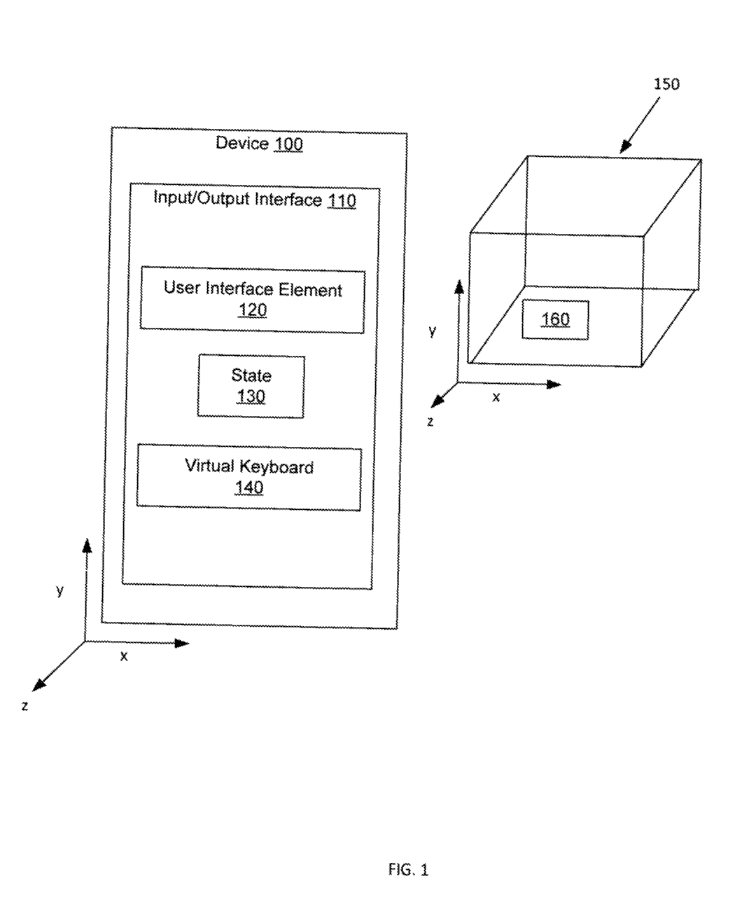

FIG. 1 illustrates an example device 100 that is hover-sensitive. Device 100 includes an input/output (i/o) interface 110. I/O interface 110 is hover-sensitive. I/O interface 110 may display a set of items including, for example, a virtual keyboard 140 and, more generically, a user interface element 120. User interface elements may be used to display information and to receive user interactions. Conventionally, user interactions were performed either by touching the i/o interface 110 or by hovering in the hover space 150. Example apparatus facilitate identifying and responding to input actions that use hover actions for controlling game play.

Device 100 or i/o interface 110 may store state 130 about the user interface element 120, a virtual keyboard 140, other devices with which device 100 is in data communication or operably connected to, or other items. The state 130 of the user interface element 120 may depend on the order in which hover actions occur, the number of hover actions, whether the hover actions are static or dynamic, whether the hover actions describe a gesture, or on other properties of the hover actions. The state 130 may include, for example, the location of a hover action, a gesture associated with the hover action, or other information.

The device 100 may include a proximity detector that detects when an object (e.g., digit, pencil, stylus with capacitive tip) is close to but not touching the i/o interface 110. The proximity detector may identify the location (x, y, z) of an object 160 in the three-dimensional hover space 150, where x and y are orthogonal to each other and in a plane parallel to the surface of the interface 110, and z is perpendicular to the surface of interface 110. The proximity detector may also identify other attributes of the object 160 including, for example, the speed with which the object 160 is moving in the hover space 150, the orientation (e.g., pitch, roll, yaw) of the object 160 with respect to the hover space 150, the direction in which the object 160 is moving with respect to the hover space 150 or device 100, a gesture being made by the object 160, or other attributes of the object 160. While a single object 160 is illustrated, the proximity detector may detect more than one object in the hover space 150.

In different examples, the proximity detector may use active or passive systems. In one embodiment, a single apparatus may perform the proximity detector functions. The detector may use sensing technologies including, but not limited to, capacitive, electric field, inductive, Hall effect, Reed effect, Eddy current, magneto resistive, optical shadow, optical visual light, optical infrared (IR), optical color recognition, ultrasonic, acoustic emission, radar, heat, sonar, conductive, and resistive technologies. Active systems may include, among other systems, infrared or ultrasonic systems. Passive systems may include, among other systems, capacitive or optical shadow systems. In one embodiment, when the detector uses capacitive technology, the detector may include a set of capacitive sensing nodes to detect a capacitance change in the hover space 150 or on the i/o interface 110. The capacitance change may be caused, for example, by a digit(s) (e.g., finger, thumb) or other object(s) (e.g., pen, capacitive stylus) that come within the detection range of the capacitive sensing nodes.

In general, a proximity detector includes a set of proximity sensors that generate a set of sensing fields in the hover space 150 associated with the i/o interface 110. The proximity detector generates a signal when an object is detected in the hover space 150. The proximity detector may characterize a hover action. Characterizing a hover action may include receiving a signal from a hover detection system (e.g., hover detector) provided by the device. The hover detection system may be an active detection system (e.g., infrared, ultrasonic), a passive detection system (e.g., capacitive), or a combination of systems. The signal may be, for example, a voltage, a current, an interrupt, a computer signal, an electronic signal, or other tangible signal through which a detector can provide information about an event the detector detected. In one embodiment, the hover detection system may be incorporated into the device or provided by the device.

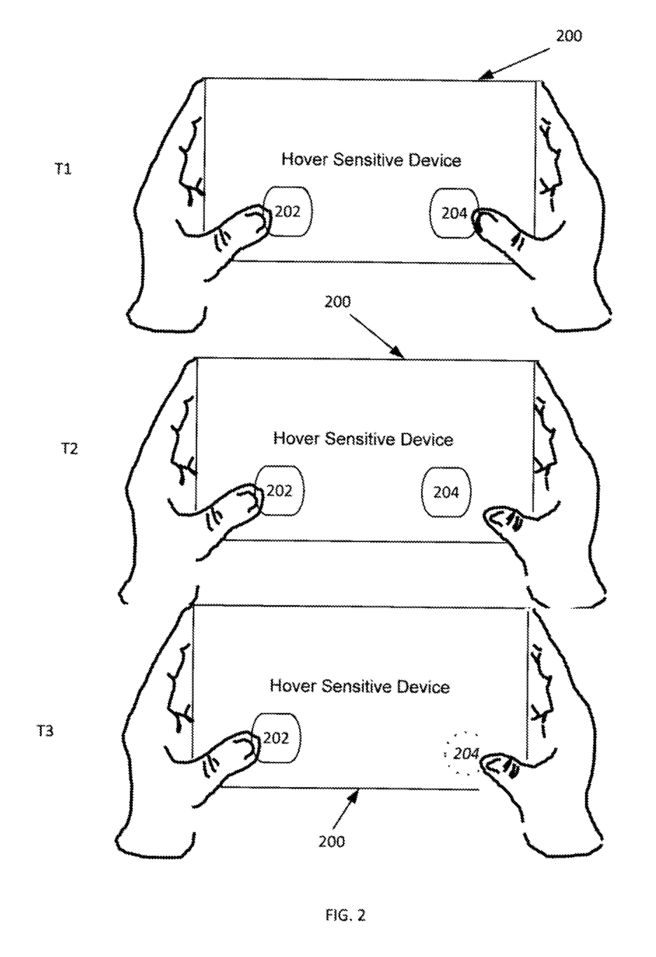

FIG. 2 illustrates a hover-sensitive device 200 at three points in time. At a first time T1, a user is holding the device 200 with their left thumb positioned over a virtual joystick 202 and with their right thumb positioned over a virtual joystick 204. At a second time T2, the user still has their left thumb over virtual joystick 202 but has moved their right thumb away from virtual joystick 204. A conventional system would no longer be able to receive inputs from the right thumb. Example apparatus and methods are not so limited. Instead, at a time T3, the virtual joystick 204 has automatically relocated to once again be under the right thumb. Thus, FIG. 2 illustrates how a virtual user interface element (e.g., joystick, game input element) may follow an object (e.g., gamer thumb, gamer finger) in a hover space to provide improved game mechanics over conventional systems.

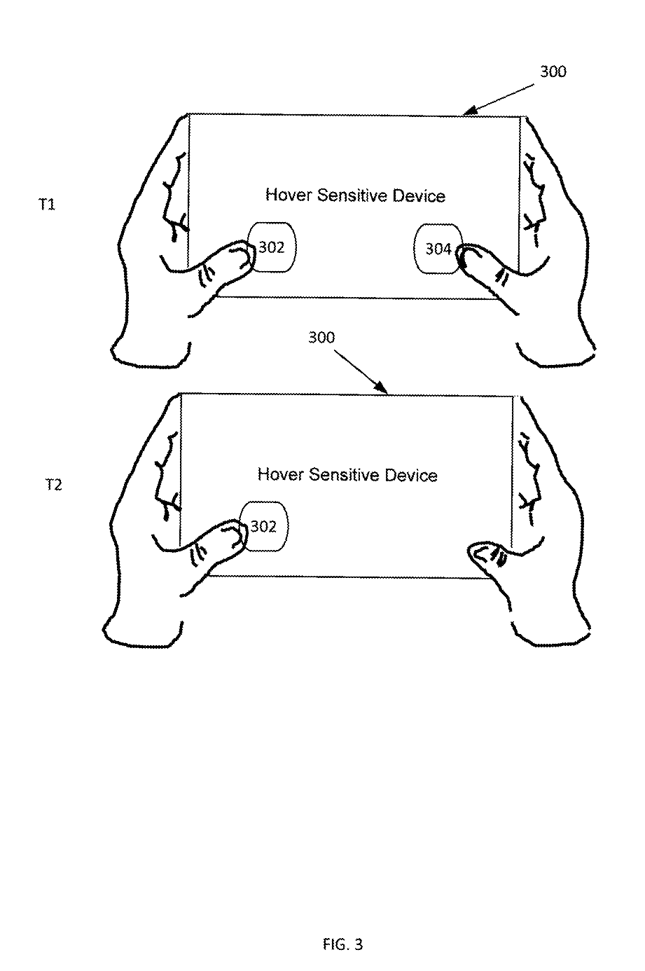

FIG. 3 illustrates a hover-sensitive device 300 at two points in time. At a first time T1, a user is holding device 300 with their left thumb positioned over a virtual joystick 302 and with their right thumb positioned over a virtual joystick 304. At a second time T2, the user may still be holding the device 300 in the same way, but virtual joystick 304 is no longer displayed. A virtual gaming input element (e.g., joystick, collective) may be selectively displayed, which means also being selectively not displayed, based, for example, on conditions in the game. If the right thumb is not providing any inputs, then there may be no reason to display joystick 304. Additionally, once the user has had their right thumb bound to the virtual joystick 304 there may no longer be any reason to display the virtual joystick 304. By selectively not displaying the virtual joystick 304, or other virtual game controls, example apparatus improve over conventional systems that consume real estate displaying controls.

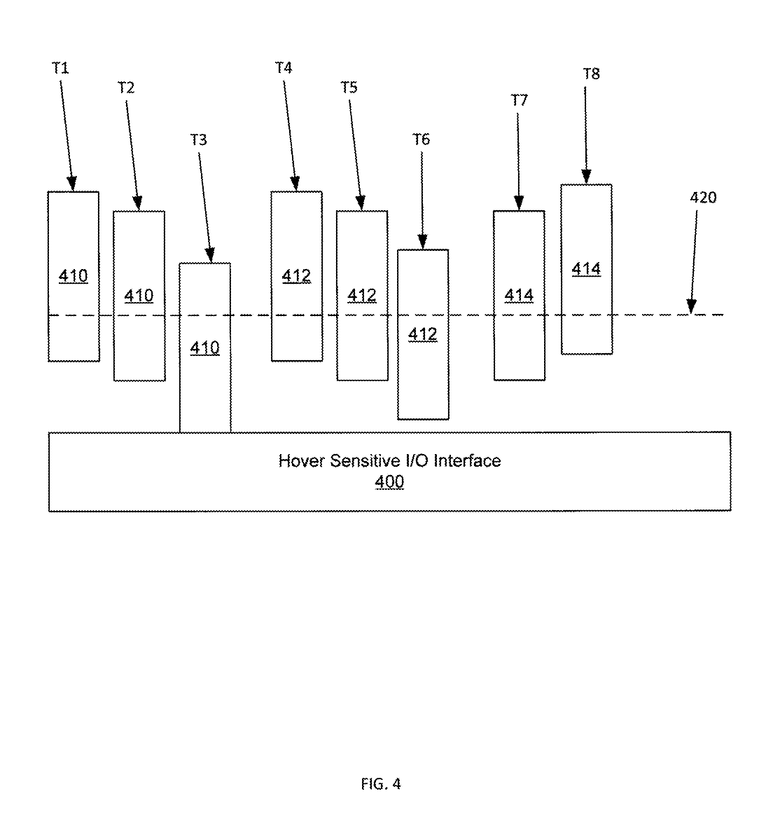

FIG. 4 illustrates hover actions associated with a punch, a fake, and a block in a first person striking game. A hover-sensitive input/output interface 400 may provide a hover space having an outer limit illustrated by line 420. At a first time T1, an object 410 (e.g., gamer thumb) may be positioned in the hover space. At a second time T2, the object 410 may approach the interface 400, This may produce a hover event (e.g., hover move, hover advance). At a third time T3, the object 410 may touch the interface 400. This may produce a hover or touch event (e.g., hover to touch transition, touch). The positions of object 410 at times T1, T2, and T3 may represent a punch being thrown in a first person boxing game. Conversely, the positions of object 412 at times T4, T5, and T6 may represent a punch being faked in the first person boxing game. For example, at time T4 the object 412 may be positioned in the hover space, at time T5 the object 412 may approach the interface 400, but at time T8 the object 412 may halt its approach before touching the interface. If the object 412 approaches the interface at a sufficient rate then a fake punch may be presented in the boxing game. The positions of object 414 at times T7 and T8 may represent a blocking action. For example, at a time T7 the object 414 may be positioned in the hover space and at a time T8 the object 414 may retreat from the interface 400. The retreat may produce a hover event (e.g., hover move, hover retreat) that can be used to produce a blocking action in the boxing game. Other sequences of hover events or hover and touch events may be used to produce punches, fake punches, or blocks.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

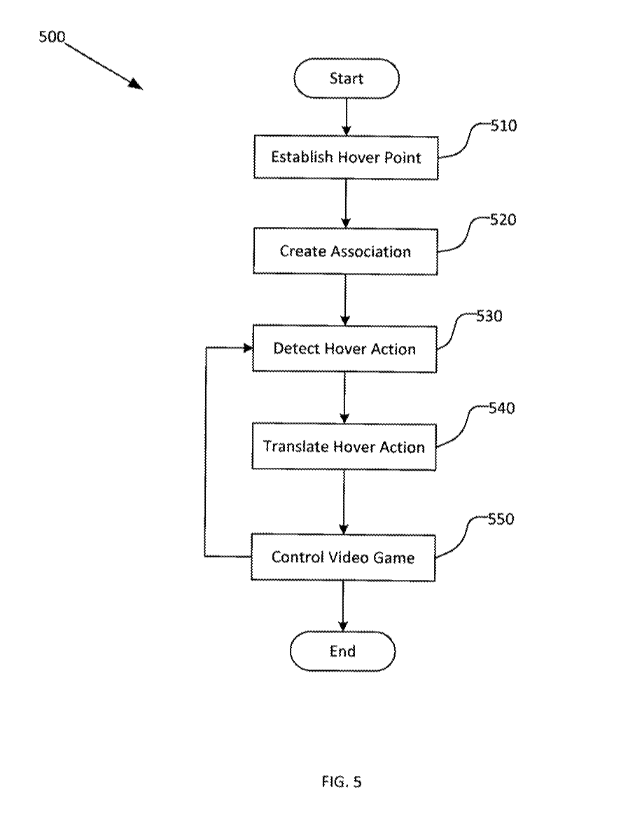

FIG. 5 illustrates an example method 500 associated with advanced game mechanics in a hover-sensitive device. Method 500 includes, at 510, establishing, for an apparatus that is displaying an output of a video game, a hover point for an object located in a hover space produced by the apparatus. The object may be, for example, a digit (e.g., thumb, finger), a stylus, or other instrument associated with a video game.

Method 500 may also include, at 520, creating an association between a virtual joystick and the hover point. The virtual joystick will process inputs from the hover space. The inputs may be processed in response to hover actions. Creating the association may include, for example, linking an object to a thread or process, writing an object identifier into a memory location, writing an object identifier into a register, providing data identifying the hover point to a thread or process, or other tangible action. While a virtual joystick is described, more generally a virtual game input element may be provided.

Method 500 may also include, at 530, detecting a hover action performed by the object. The hover action may be, for example, a hover enter event, a hover move event, a hover gesture, or other hover action. The hover action may be described, at least in part, using data associated with an x dimension and a y dimension that define a plane that is parallel to the surface of the apparatus, and using data associated with a z dimension that is perpendicular to the plane defined by the x dimension and the y dimension. The hover action may produce data about a z dimension of the action. Thus, detecting the hover action at 530 may include characterizing a z dimension component of the hover action. Characterizing the z dimension component of the hover action may include, for example, determining a distance between the object and the apparatus, determining a rate at which the object is approaching the apparatus, or determining a rate at which the object is moving away from the apparatus.

Method 500 may also include, at 540, translating the hover action to an input associated with the virtual joystick. Translating the hover action may include, for example, producing data that may have been produced if a physical joystick had been moved in a direction. For example, a hover action may be translated to a left/right motion signal, into a forward/backward motion signal, and into a z dimension component signal.

Method 500 may also include, at 550, controlling the video game based on the input. Since the hover action has the z dimension component, and since the input is produced from data associated with the hover action, the video game is controlled based, at least in part, on the z dimension component. Controlling the video game at 550 may take different forms depending, for example, on whether the video game is a first person game or a third person game.

In one embodiment, controlling the video game at 550 may include causing an element in the video game to appear to move in the z dimension. For example, a character may appear to crouch when the hover event included a gamers finger moving toward the screen and a character may appear to stand up when the hover event included a gamer's finger moving away from the screen. Rather than moving an entire character, a portion of a character may move or an instrument wielded by or associated with the character may move. For example, a character's hand, foot, head, or other body part may move up or down based on the z dimension component.

In one embodiment, controlling the video game at 550 may include controlling an intensity of an action in the video game. For example, the amount of water being expelled from a fire hose may be controlled by how far away the gamer's finger is from the screen. In one embodiment, controlling the video game at 550 may include controlling a volume or area in which an effect occurs in the video game. For example, the area over which pixie dust is spread when a mage casts a spell may be determined by how far from the screen the gamer's fingers are when the spell is cast.

One type of first person game is a striking game. Example striking games are boxing games, mixed martial arts games, ping pong games, and other games where a user is hitting something and perhaps being hit themselves. When the video game is a striking game, then striking (e.g., punching, kicking) faking, and blocking may be controlled by the z component. For example, the speed in the z dimension may control the strength of a punch or kick. The strength of the punch or kick may be tied to a rate at which the character in the game tires. A punch may be completed when, for example, a touch event follows the hover approach event. However, a punch may be faked when, for example, the hover approach event occurs but then a hover stop or retreat event occurs without touching the screen. Conventional striking games may be able to strike using a touch event but may not be able to produce a fake punch or kick. A block may be executed by, for example, retreating a thumb that is controlling a hand through the virtual joystick away from the screen. When executing a block, the x component of an input may position a glove in the left/right direction, the y component of the input may position a glove in the up/down direction, and the z component of the input may position the glove closer to the character. A strike, fake, or block may be executed in other ways.

Another type of first person game is a locomotion game. Example locomotion games are surfing games, skateboarding games, driving games, flying games, and other games where a user is moving from place to place under their own power or aided by a machine (e.g., car, plane, jet ski). In a locomotion game, the x component of an input may control whether the person or object is moved left or right, the y component of an input may control whether the person or object is moved forwards or backwards, and the z component may control other attributes of motion. For example, the z component may control a direction of motion (e.g., up, down), a rate of acceleration (e.g., braking, pressing the gas), a direction of acceleration (e.g., up down), or other attributes.

Recall that one issue with conventional apparatus where a physical or virtual control (e.g., joystick) is fixed to a location is that screen real estate is consumed by the control and that a finger, thumb, or hand may occlude even more screen real estate. Therefore, in one embodiment, method 500 may include only selectively displaying the virtual control on the apparatus. In some applications there may be no need to display the virtual control after, for example, the user has positioned their thumbs a first time and hover points have been bound to the thumbs. However, at some point there may be a need to redisplay the control to allow the user to regain possession of the control. Thus, method 500 may include selectively displaying and hiding the virtual control.

Recall that another issue with conventional apparatus where a physical or virtual control is fixed to a location is that the gamer's thumbs may slip off the control. Thus, method 500 may include maintaining the association between the virtual joystick and the object as the object moves in the hover space. In one embodiment, a virtual joystick may be able to follow a thumb to any location on a display while in another embodiment a virtual joystick may be constrained to follow a thumb to a finite set of locations on a display.

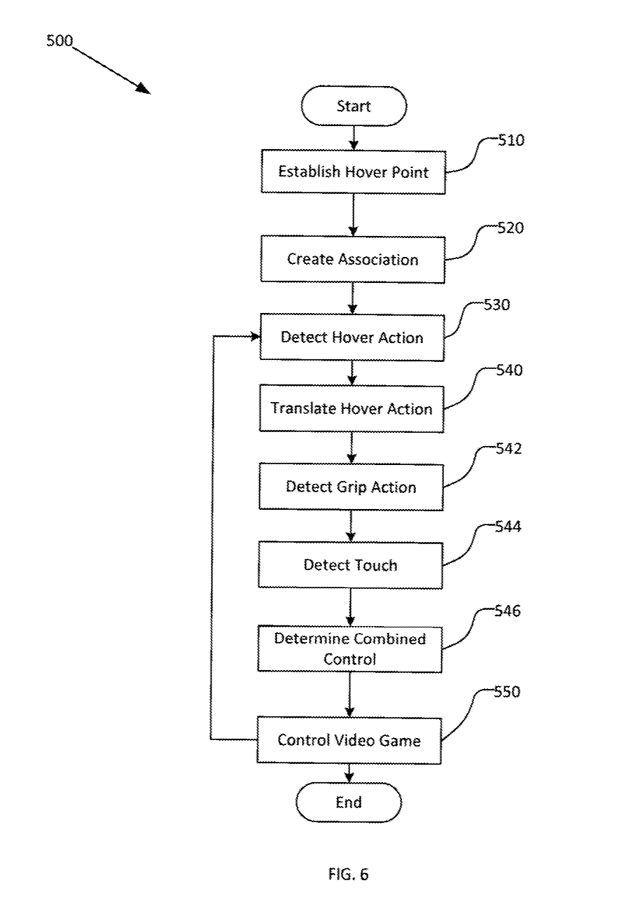

FIG. 6 illustrates another embodiment of method 500. This embodiment includes additional actions. For example, this embodiment includes, at 542, detecting a grip action at the apparatus. The grip action may be, for example, a flick action, a drag action, an n-squeeze action, an n-tap action, a squeeze intensity action, or other action. The grip action may occur at locations other than at the hover-sensitive interface including the top of the apparatus, the bottom of the apparatus, the sides of the apparatus, or the back of the apparatus. A flick action may be, for example, a linear or curvilinear movement of a digit more than a threshold distance faster than a threshold speed. A drag action may be, for example, a linear or curvilinear movement of a digit more than a threshold distance slower than the threshold speed. A flick action may cause a character to move quickly (e.g., hop left, hop right) while a drag action may cause a character to move slowly (e.g., lean left, lean right). An n-tap action may be, for example, n taps on the apparatus, where n is an integer greater than or equal to one. Similarly, an n-squeeze action may be, for example, n squeezes on the apparatus. A squeeze intensity action may be, for example, a squeeze that lasts longer than a threshold duration and that produces more than a threshold pressure. A squeeze intensity action may be used to control, for example, how much pressure is applied by a hand. For example, in a personal combat game, the strength of a choke or grasp may be controlled by a squeeze intensity action. In a role playing game where a character is able to cast a spell, a squeeze intensity action may control the strength or area/volume of effect of the spell. For example, a tight squeeze may cause a spell to be widely distributed while a light squeeze may cause a spell to be less widely distributed.

This embodiment may also include, at 544, detecting a touch or accelerometer action at the apparatus. The touch may be performed on the hover interface. For example, in a boxing game, a hover approach event may direct a punch with a certain speed in a certain direction and the touch event may terminate the punch.

This embodiment may also include, at 546, determining a combined control. The combined control may combine the input with the grip action. Additionally or alternatively, the combined control may combine the input with the touch or accelerometer action. In one embodiment, the combined control may combine the input with the grip action and the touch or accelerometer action. In this embodiment, the control exercised at 550 may then be based on the input or the combined control.

While FIGS. 5 and 6 illustrate various actions occurring in serial, it is to be appreciated that various actions illustrated in FIGS. 5 and 6 could occur substantially in parallel. By way of illustration, a first process could detect and process hover events, a second process could translate hover events to virtual joystick commands or inputs that include a z dimension component, and a third process could control a video game based on the virtual joystick commands or inputs. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 500 or 600. While executable instructions associated with the listed methods are described as being stored on a computer-readable storage medium, it is to be appreciated that executable instructions associated with other example methods described or claimed herein may also be stored on a computer-readable storage medium. In different embodiments, the example methods described herein may be triggered in different ways. In one embodiment, a method may be triggered manually by a user. In another example, a method may be triggered automatically.

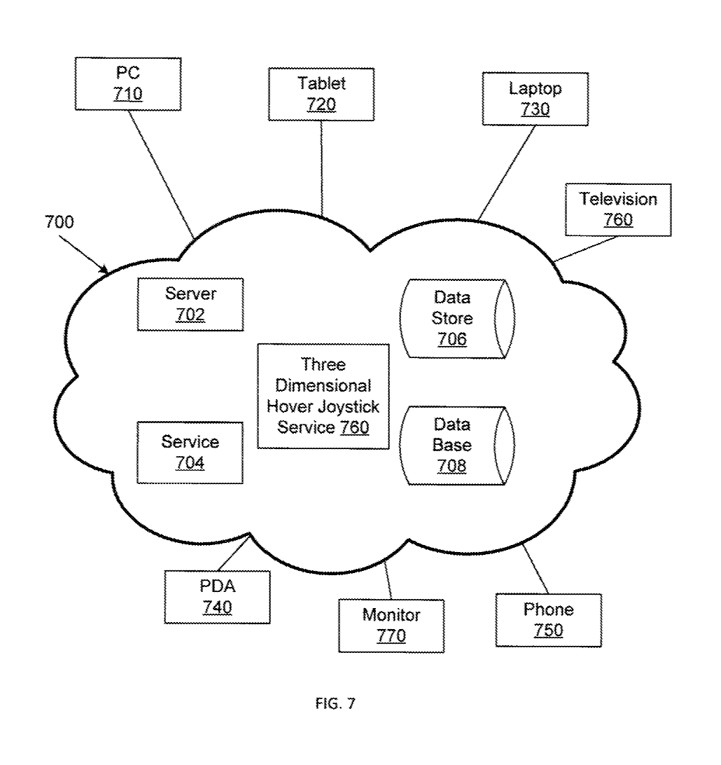

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example three dimensional hover joystick service 760 residing in the cloud 700. The three dimensional hover joystick service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud 700 and may, therefore, be used by the three dimensional hover joystick service 760.

FIG. 7 illustrates various devices accessing the three dimensional hover joystick service 760 in the cloud 700. The devices include a computer 710, a tablet 720, a laptop computer 730, a desktop monitor 770, a television 760, a personal digital assistant 740, and a mobile device (e.g., cellular phone, satellite phone) 750. While many devices may potentially access the three dimensional hover joystick service 760, hover-sensitive devices like a smartphone or tablet computer may rely on the three dimensional hover joystick service 760 more frequently. It is possible that different users at different locations using different devices may access the three dimensional hover joystick service 760 through different networks or interfaces. In one example, the three dimensional hover joystick service 760 may be accessed by a mobile device 750. In another example, portions of three dimensional hover joystick service 760 may reside on a mobile device 750. Three dimensional hover joystick service 760 may perform actions including, for example, binding a user interface element to an object in a hover space, handling hover events, generating control inputs, or other services. In one embodiment, three dimensional hover joystick service 760 may perform portions of methods described herein (e.g., method 500, method 600).

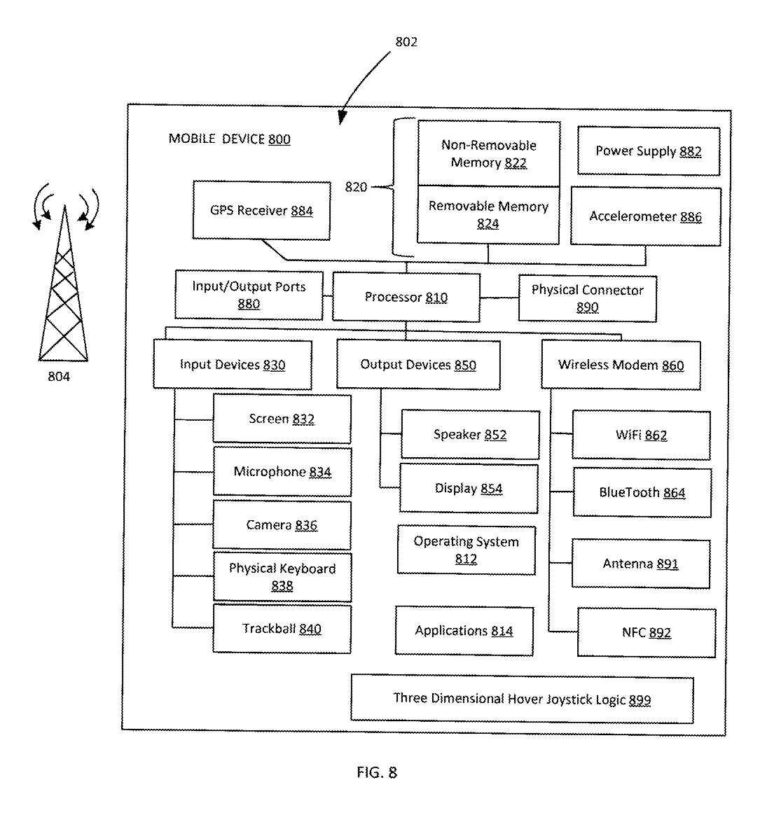

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), etc.) and may allow wireless two-way communications with one or more mobile communications networks 804, such as a cellular or satellite networks.

Mobile device 800 can include a controller or processor 810 (e.g., signal processor, microprocessor, application specific integrated circuit (ASIC), or other control and processing logic circuitry) for performing tasks including touch detection, hover detection, signal coding, data processing, input/output processing, power control, or other functions. An operating system 812 can control the allocation and usage of the components 802 and support application programs 814. The application programs 814 can include mobile computing applications (e.g., email applications, calendars, contact managers, web browsers, messaging applications), video games, movie players, television players, productivity applications, or other computing applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is known in GSM communication systems, or other memory storage technologies, such as “smart cards.” The memory 820 can be used for storing data or code for running the operating system 812 and the applications 814. Example data can include hover action data, shared hover space data, shared display data, user interface element state, cursor data, hover control data, hover action data, control event data, web pages, text, images, sound files, video data, or other data sets. The memory 820 can store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a screen 832 that is hover-sensitive, a microphone 834, a camera 836, a physical keyboard 838, or trackball 840. The mobile device 800 may also support output devices 850 including, but not limited to, a speaker 852 and a display 854. Display 854 may be incorporated into a hover-sensitive i/o interface. Other possible input devices (not shown) include accelerometers (e.g., one dimensional, two dimensional, three dimensional). Other possible output devices (not shown) can include piezoelectric or other haptic output devices. Some devices can serve more than one input/output function. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include, motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (electro-encephalogram (EEG) and related methods). Thus, in one specific example, the operating system 812 or applications 814 can comprise speech-recognition software as part of a voice user interface that allows a user to operate the device 800 via voice commands. Further, the device 800 can include input devices and software that allow for user interaction via a user's spatial gestures, such as detecting and interpreting hover gestures that may affect more than a single device.

A wireless modem 880 can be coupled to an antenna 891. In some examples, radio frequency (RF) filters are used and the processor 810 need not select an antenna configuration for a selected frequency band. The wireless modem 860 can support two-way communications between the processor 810 and external devices that have displays whose content or control elements may be controlled, at least in part, by three dimensional hover joystick logic 899. The modern 860 is shown generically and can include a cellular modem for communicating with the mobile communication network 804 and/or other radio-based modems (e.g., Bluetooth 864 or Wi-A 862). The wireless modem 860 may be configured for communication with one or more cellular networks, such as a Global System for Mobile communications (GSM) network for data and voice communications within a single cellular network, between cellular networks, or between the mobile device and a public switched telephone network (PSTN). Mobile device 800 may also communicate locally using, for example, near field communication (NFC) element 892.

The mobile device 800 may include at least one input/output port 880, a power supply 882, a satellite navigation system receiver 884, such as a Global Positioning System (GPS) receiver, an accelerometer 886, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include a three dimensional hover joystick logic 899 that provides a functionality for the mobile device 800. For example, three dimensional hover joystick logic 899 may provide a client for interacting with a service (e.g., service 760, FIG. 7). Portions of the example methods described herein may be performed by three dimensional hover joystick logic 899. Similarly, three dimensional hover joystick logic 899 may implement portions of apparatus described herein.

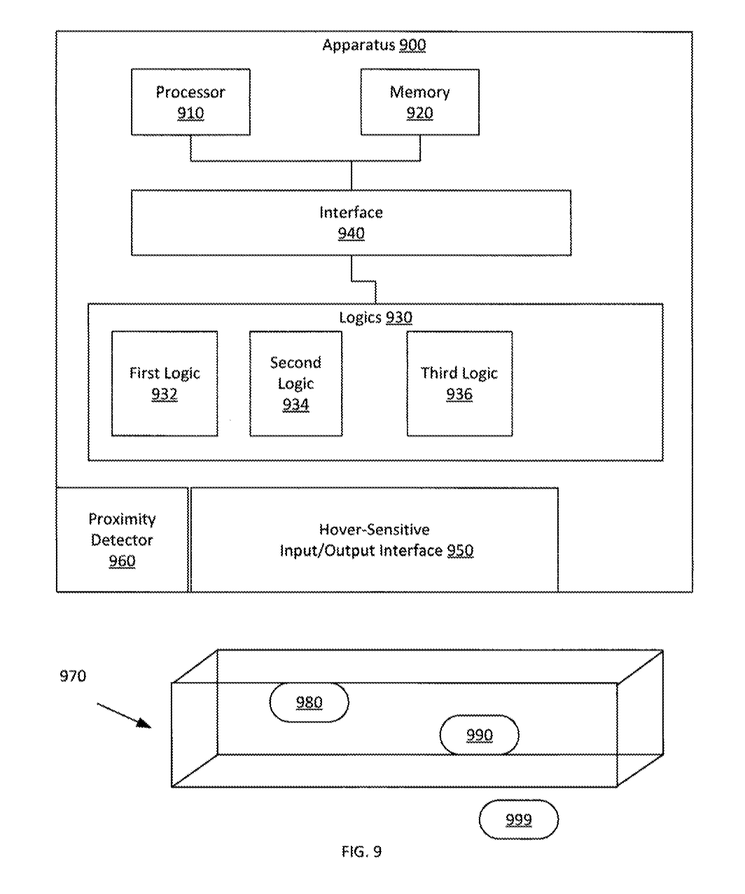

FIG. 9 illustrates an apparatus 900 that provides a virtual control (e.g., joystick) that accepts inputs in three dimensions. In one example, the apparatus 900 includes an interface 940 that connects a processor 910, a memory 920, a set of logics 930, a proximity detector 960, and a hover-sensitive i/o interface 950. The set of logics 930 may control the apparatus 900 in response to a hover gesture performed in a hover space 970 associated with the input/output interface 950. The set of logics 930 may provide a virtual hover control (e.g., joystick) for display on the input/output interface 950. The virtual hover control may be responsive to an object in the hover space 970. A position in the hover space 970 may be described using an x dimension and a y dimension that define a plane that is parallel to the surface of the input/output interface 950 and a z dimension that is perpendicular to the plane defined by the x dimension and the y dimension. In one embodiment, the proximity detector 960 may include a set of capacitive sensing nodes that provide hover-sensitivity for the input/output interface 950. Elements of the apparatus 900 may be configured to communicate with each other, but not all connections have been shown for clarity of illustration.

The proximity detector 960 may detect an object 980 in the hover space 970 associated with the apparatus 900. The hover space 970 may be, for example, a three dimensional volume disposed in proximity to the i/o interface 950 and in an area accessible to the proximity detector 960. The hover space 970 has finite bounds. Therefore the proximity detector 960 may not detect an object 999 that is positioned outside the hover space 970. The position of the object 980 may be described using (x,y,z) co-ordinates or other positional information (e.g., polar co-ordinates, range plus azimuth).

Apparatus 900 may include a first logic 932 that processes a hover event generated by the object 980. The hover event may be, for example, a hover enter, a hover exit, a hover move, or other event. The hover event provides a first input to the virtual hover control. The first input will have a z dimension element. Having a z dimension element means that unlike conventional controls that only provide (x,y) data (e.g., lateral movement, front/back movement), the example hover control provides (x,y,z) data, where the z data may describe, for example, a z position of the object 980, or a rate of change in the z direction of the object 980. In one embodiment, the first logic 932 binds the object 980 to the virtual hover control and maintains the binding as the object moves in the hover space 970. Binding the object 980 to the virtual hover control may include, for example, storing data in a data structure, storing data in an object, connecting a data structure or object to a process, writing an entry to a database table, or other tangible action. Unlike a conventional physical control that has a fixed physical position, and unlike a conventional virtual control that also has a fixed physical position, the virtual hover control may not have a fixed physical position. Since the virtual hover control does not have a fixed physical position, the virtual hover control may virtually move around as a hover point associated with object 980 moves around. When object 980 is a gamers thumb and the virtual hover control is a joystick, once the gamers thumb has been bound to the joystick, the joystick may follow the user's thumb as it moves to different locations on input/output interface 950.

Apparatus 900 may include a second logic 934 that produces a video game control event based on the first input. The video game control event may control an element of the video game in the z dimension. By way of illustration, when the video game is a first person game (e.g., personal combat, driving, flying), then the video game control may control the location or acceleration of a virtual body part (e.g., hand, foot, head) in the z dimension, may control the location or acceleration of a virtual body in the z dimension, may control the location or acceleration of an object (e.g., weapon, ball, thrown item) in the z dimension, or may control another attribute of the first person game. By way of further illustration, when the video game is a third person game (e.g., strategy, magical role playing, squad level control) then the video game control event may control a volume or area in which an effect (e.g., spell) is active for the video game, may control an intensity of an action (e.g., spell) for the video game, may control a zoom level for the video game, or may control another attribute of the third person game.

Apparatus 900 may include a third logic 936 that processes a grip event generated in a grip space associated with the apparatus 900. The grip event may be, for example, a momentary squeeze, a longer than momentary squeeze, an n-tap, or other event. The grip event may cause a second input to be produced by apparatus 900. In this embodiment, the second logic 934 produces the video game control event based on the first input associated with the hover event and the second input associated with the grip event. In one embodiment, the third logic 936 may process a touch event generated by an item touching the input/output interface 950. The touch event may be, for example, an n-tap, a drag, a flick, or other touch event. The touch event may cause a third input to be produced by apparatus 900. in this embodiment, the second logic 934 produces the video game control event based on the first input, the second input, and the third input.

Apparatus 900 may include a memory 920. Memory 920 can include non-removable memory or removable memory. Non-removable memory may include random access memory (RAM), read only memory (ROM), flash memory, a hard disk, or other memory storage technologies. Removable memory may include flash memory, or other memory storage technologies, such as “smart cards.” Memory 920 may be configured to store user interface state information, characterization data, object data, data about a floating three dimensional joystick, or other data.

Apparatus 900 may include a processor 910. Processor 910 may be, for example, a signal processor, a microprocessor, an application specific integrated circuit (ASIC), or other control and processing logic circuitry for performing tasks including signal coding, data processing, input/output processing, power control, or other functions.

In one embodiment, the apparatus 900 may be a general purpose computer that has been transformed into a special purpose computer through the inclusion of the set of logics 930. Apparatus 900 may interact with other apparatus, processes, and services through, for example, a computer network.

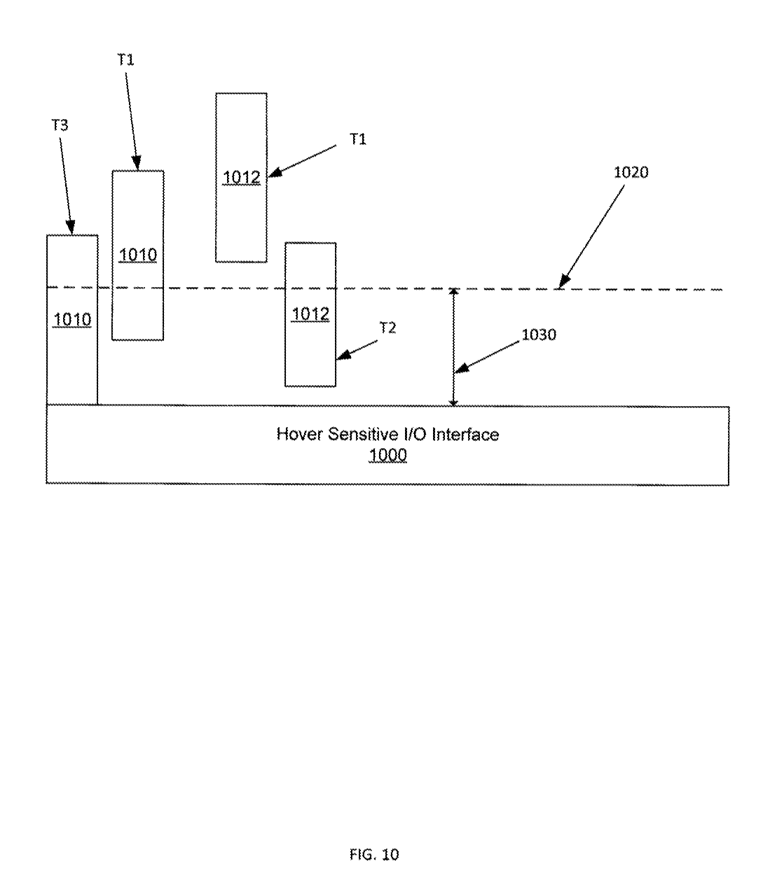

FIG. 10 illustrates a hover-sensitive i/o interface 1000. Line 1020 represents the outer limit of the hover-space associated with hover-sensitive i/o interface 1000. Line 1020 is positioned at a distance 1030 from i/o interface 1000. Distance 1030 and thus line 1020 may have different dimensions and positions for different apparatus depending, for example, on the proximity detection technology used by a device that supports i/o interface 1000.

Example apparatus and methods may identify objects located in the hover-space bounded by i/o interface 1000 and line 1020. Example apparatus and methods may also identify items that touch i/o interface 1000. For example, at a first time T1, an object 1010 may be detectable in the hover-space and an object 1012 may not be detectable in the hover-space. At a second time T2, object 1012 may have entered the hover-space and may actually come closer to the i/o interface 1000 than object 1010. At a third time T3, object 1010 may come in contact with i/o interface 1000. When an object enters or exits the hover space an event may be generated. When an object moves in the hover space an event may be generated. When an object touches the i/o interface 1000 an event may be generated. When an object transitions from touching the i/o interface 1000 to not touching the i/o interface 1000 but remaining in the hover space an event may be generated. Example apparatus and methods may interact with events at this granular level (e.g., hover enter, hover exit, hover move, hover to touch transition, touch to hover transition) or may interact with events at a higher granularity (e.g., hover gesture). Generating an event may include, for example, making a function call, producing an interrupt, updating a value in a computer memory. updating a value in a register, sending a message to a service, sending a signal, or other action that identifies that an action has occurred. Generating an event may also include providing descriptive data about the event. For example, a location where the event occurred, a title of the event, and an object involved in the object may be identified.

In computing, an event is an action or occurrence detected by a program that may be handled by the program. Typically, events are handled synchronously with the program flow. When handled synchronously, the program may have a dedicated place where events are handled. Events may be handled in, for example, an event loop. Typical sources of events include users pressing keys, touching an interface, performing a gesture, or taking another user interface action. Another source of events is a hardware device such as a timer. A program may trigger its own custom set of events. A computer program that changes its behavior in response to events is said to be event-driven.

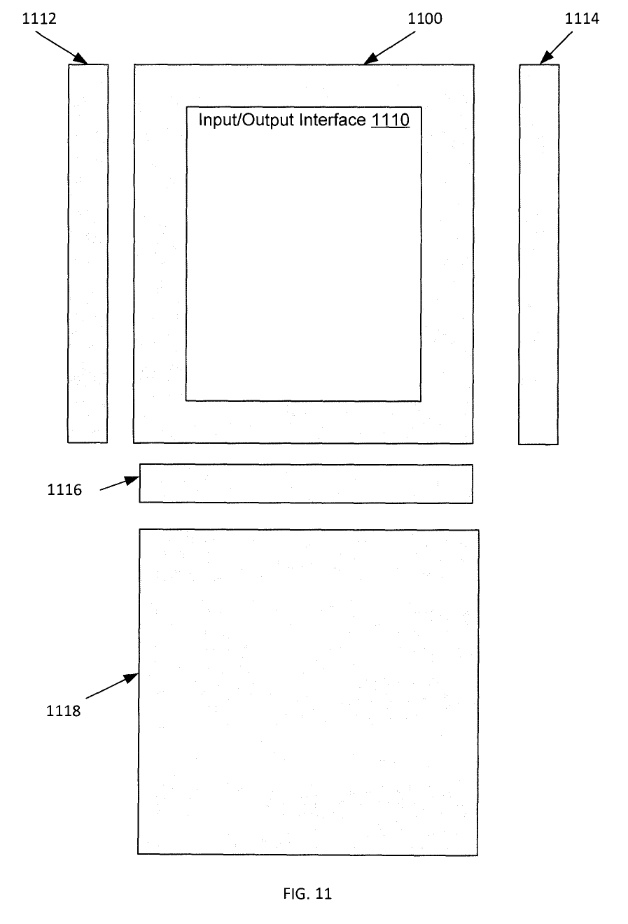

FIG. 11 illustrates a front view of apparatus 1100, a view of the left edge 1112 of apparatus 1100, a view of the right edge 1114 of apparatus 1100, a view of the bottom edge 1116 of apparatus 1100, and a view of the back 1118 of apparatus 1100. Conventionally there may not have been touch sensors located on the edges 1112, 1114, the bottom 1116, or the back 1118. To the extent that conventional devices may have included touch sensors those sensors may not have been used to detect how an apparatus is being gripped and may not have provided information upon which control events may be generated. Sensors located on the edges of apparatus 1100 may provide a grip space for apparatus 1100.

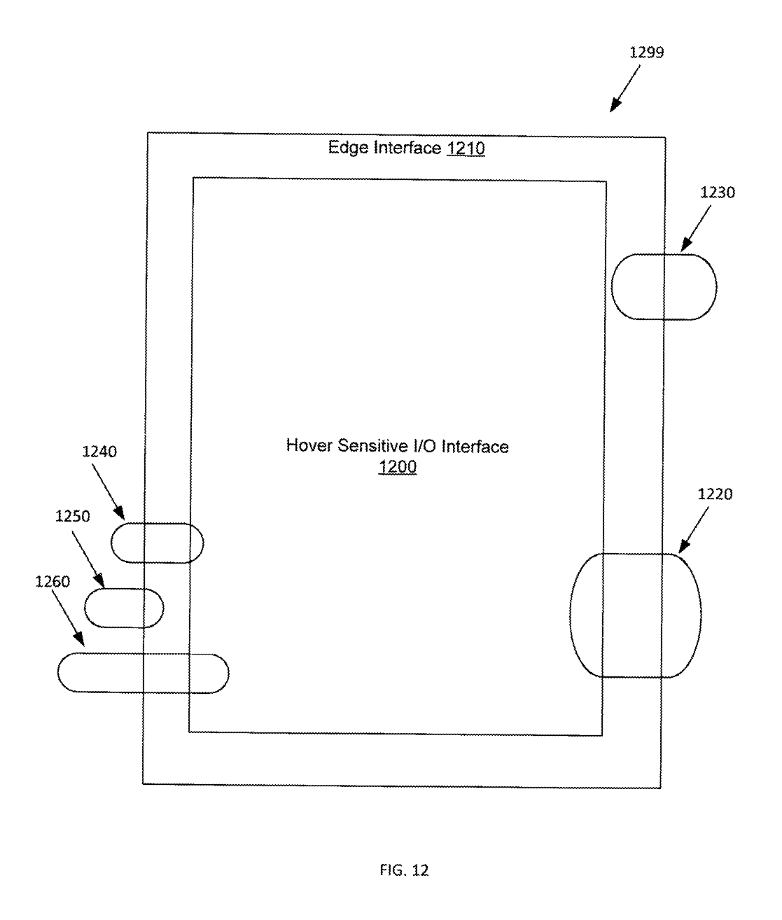

FIG. 12 illustrates an example apparatus 1299 that provides a grip space. Apparatus 1299 includes an interface 1200 that may be touch or hover-sensitive. Apparatus 1299 also includes an edge interface 1210 that is touch sensitive. Interface 1200 and edge interface 1210 may provide a grip space for apparatus 1299. Edge interface 1210 may detect, for example, the location of palm 1220, thumb 1230, and fingers 1240, 1250, and 1260. Interface 1200 may also detect, for example, palm 1220 and fingers 1240 and 1260. In one embodiment, grip events may be identified based on the touch points identified by edge interface 1210. In another embodiment, other grip events may be identified based on the touch or hover points identified by i/o interface 1200. In yet another embodiment, grip events may be identified based on data from the edge interface 1210 and the i/o interface 1200. Edge interface 1210 and i/o interface 1200 may be separate machines, circuits, or systems that co-exist in apparatus 1299. An edge interface (e.g., touch interface with no display) and an i/o interface (e.g., display) may share resources, circuits, or other elements of an apparatus, may communicate with each other, may send events to the same or different event handlers, or may interact in other ways.

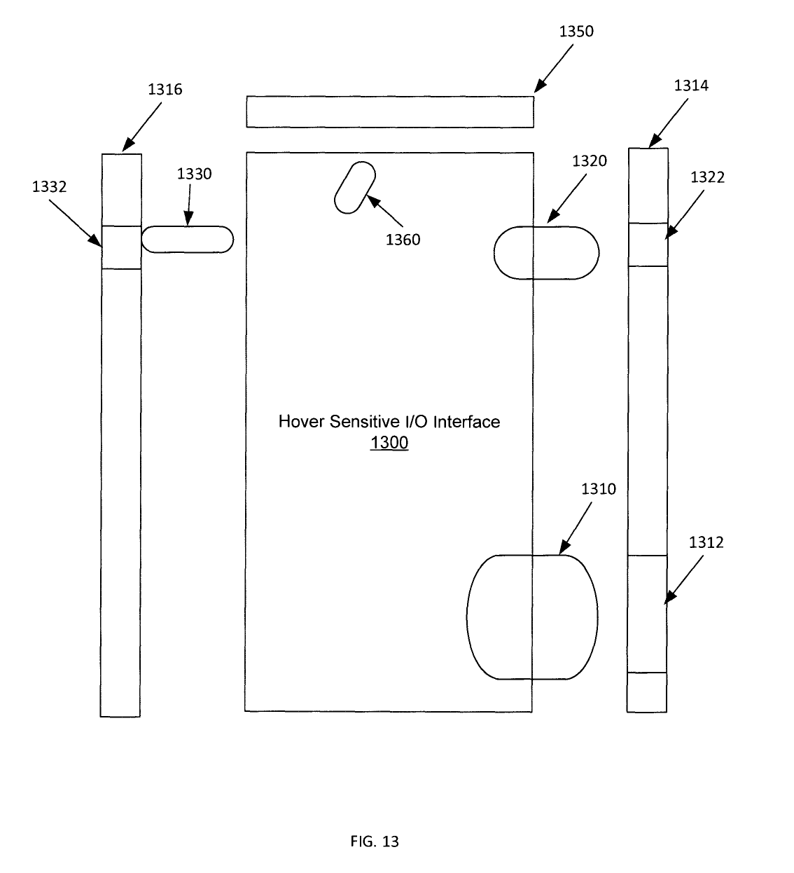

FIG. 13 illustrates an apparatus where sensors on an input/output interface 1300 co-operate with sensors on edge interfaces to provide a grip space that may detect a grip event, I/O interface 1300 may be, for example, a display. Palm 1310 may be touching right side 1314 at location 1312. Palm 1310 may also be detected by hover-sensitive i/o interface 1300. Thumb 1320 may be touching right side 1314 at location 1322. Thumb 1320 may also be detected by interface 1300. Finger 1360 may be near but not touching top 1350 and thus not detected by an edge interface but may be detected by interface 1300. Finger 1330 may be touching left side 1336 at location 1332 but may not be detected by interface 1300. Based on the combination of inputs from the interface 1300 and from touch sensors on right side 1314, top 1350 and left side 1316, various grip events may be detected.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
establishing, for an apparatus that is displaying an output of a video game, a hover point for an object located in a hover space produced by the apparatus;
creating an association between a virtual joystick and the hover point, where the virtual joystick processes inputs from the hover space;
detecting a hover action performed by the object, where the hover action is described, at least in part, using an x dimension component, a y dimension component, and a z dimension component, where the x and y dimensions define a plane that is parallel to the surface of the apparatus, and the z component is perpendicular to the plane defined by the x and y dimensions;
translating the hover action to an input associated with the virtual joystick, and
controlling the video game based on the input.

2. The method of claim 1, comprising:
characterizing the z dimension component of the hover action, and
controlling the video game based, at least in part, on the z dimension component of the hover action.

3. The method of claim 2, where characterizing the z dimension component of the hover action includes determining a distance between the object and the apparatus, determining a rate at which the object is approaching the apparatus, or determining a rate at which the object is moving away from the apparatus.

4. The method of claim 3, where controlling the video game based on the z dimension component includes causing an element in the video game to appear to move in the z dimension.

5. The method of claim 3, where controlling the video game based on the z dimension component includes controlling an intensity of an action in the video game, or controlling a volume or area in which an effect occurs in the video game.

6. The method of claim 1, where the video game is a first person striking game and where striking, faking, and blocking in the first person striking game are controlled, at least in part, by the z dimension component.

7. The method of claim 1, where the video game is a first person locomotion game and where a direction of motion, a rate of acceleration, and a direction of acceleration are controlled, at least in part, by the z dimension component.

8. The method of claim 1, comprising:
detecting a grip action at the apparatus:
determining a combined control associated with the input and the grip action, and
controlling the video game based on the combined control.

9. The method of claim 8, where the grip action is a flick action, a drag action, an n-squeeze action, an n-tap action, or a squeeze intensity action.

10. The method of claim 1, comprising:
detecting a touch or accelerometer action at the apparatus;
determining a combined control associated with the input and the touch or accelerometer action, and
controlling the video game based on the combined control.

11. The method of claim 1, comprising
detecting a grip action at the apparatus;
detecting a touch or accelerometer action at the apparatus;
determining a combined control associated with the input, the grip action, and the touch or accelerometer action, and
controlling the video game based on the combined control.

12. The method of claim 1, comprising selectively displaying the virtual joystick on the apparatus.

13. The method of claim 1, comprising maintaining the association between the virtual joystick and the object as the object moves in the hover space.

14. A computer-readable storage medium storing computer-executable instructions that when executed by a computer cause the computer to perform a method, the method comprising:
establishing, for an apparatus that is displaying an output of a video game, a hover point for an object located in a hover space produced by the apparatus;
creating an association between a virtual joystick and the hover point, where the virtual joystick processes inputs from the hover space, and maintaining the association between the joystick and the object as the object moves in the hover space;
detecting a hover action performed by the object, where the hover action is described, at least in part, using an x dimension component, a y dimension component, and a z dimension component, where the x and y dimensions define a plane that is parallel to the surface of the apparatus, and the z component is perpendicular to the plane defined by the x and y dimensions;
characterizing the z dimension component of the hover action, where characterizing the z dimension component of the hover action includes determining a distance between the object and the apparatus, determining a rate at which the object is approaching the apparatus, or determining a rate at which the object is moving away from the apparatus;
translating the hover action to an input associated with the virtual joystick, where the input depends, at least in part, on the z dimension component of the hover action,
detecting a grip action at the apparatus, where the grip action is a flick action, a drag action, an n-squeeze action, an n-tap action, or a squeeze intensity action;
detecting a touch or accelerometer action at the apparatus;
determining a combined control associated with the input, the grip action, and the touch or accelerometer action, and
controlling the video game based on the input or the combined control,
where controlling the video game includes causing an element in the video game to appear to move in the z dimension, controlling an intensity of an action in the video game, or controlling a volume or area in which an effect occurs in the video game.

15. An apparatus, comprising:
a processor;
a memory;
an input/output interface that produces a hover space for the apparatus;
a set of logics that provide a virtual hover control to be displayed on the input/output interface, where the virtual hover control is responsive to an object in the hover space, where an x dimension and a y dimension define a plane that is parallel to the surface of the input/output interface, and where a z dimension is perpendicular to the plane defined by the x dimension and the y dimension, and
an interface to connect the processor, the memory, and the set of logics,
the set of logics comprising:
a first logic that processes a hover event generated by the object, where the hover event provides a first input to the virtual hover control, the first input having a z dimension element; and
a second logic that produces a video game control event based on the first input, where the video game control event controls an element of the video game in the z dimension.

16. The apparatus of claim 15, where the first logic binds the object to the virtual hover control and maintains the binding as the object moves in the hover space.

17. The apparatus of claim 15, comprising:
a third logic that processes a grip event generated in a grip space associated with the apparatus, where the grip event provides a second input; and
where the second logic produces the video game control event based on first input and the second input.

18. The apparatus of claim 17, where the third logic processes a touch event generated by an item touching the input/output interface, where the touch event provides a third input, and
where the second logic produces the video game control event based on the first input, the second input, and the third input.

19. The apparatus of claim 16, where the video game control event is associated with a first person game, and where the video game control event controls the location or acceleration of a virtual body part in the z dimension, controls the location or acceleration of a virtual body in the z dimension, or controls the location or acceleration of an object in the z dimension.

20. The apparatus of claim 16, where the video game control event is associated with a third person game, and where the video game control event controls a volume or area in which an effect is active for the video game, controls an intensity of an action for the video game, or controls a zoom level for the video game.
